(19) United States
(12) Patent Application Publication
(10) Pub. No.: US 2026/0279708 A1
(43) Pub. Date: Sep. 17, 2026

(54) Temperature Switch

(71) Applicant: UCHIYA THERMOSTAT CO., LTD., Misato-shi, Saitama (JP)

(72) Inventor: Hideaki Takeda, Misato-shi, Saitama (JP)

(73) Assignee: UCHIYA THERMOSTAT CO., LTD., Misato-shi, Saitama (JP)

(21) Appl. No.: 19/473,660

(22) PCT Filed: Apr. 10, 2024
(86) PCT No.: PCT/JP2024/014519

§ 371 Date: Oct. 8, 2025

(30) Foreign Application Priority Data
Apr. 13, 2023 (JP) 2023-065671

(51) Int. Cl. H01H 37/52; H01H 37/04

(52) U.S. Cl. CPC H01H 37/52; H01H 37/04

(57) ABSTRACT

A temperature switch having high thermal responsiveness being easily attachable to a heating element, including a base plate, a thermally actuated element disposed on the base plate, a movable plate partly joined to the base plate to move according to reversal of the thermally actuated element, including a movable contact, a fixed plate including a fixed contact capable of coming into contact with and separating from the movable contact, and an insulating plate that supports the base and fixed plates. The base plate includes a rectangular main body part supported by the insulating plate, and an extending part extending outward in a width direction from at least one of two end portions of the main body part in the width direction, and the extending part includes a plurality of bent portions, and a tip end portion of the extending part is flush with a bottom surface of the insulating plate.

This application is a national phase entry under 35 U.S.C. § 371 of International Application No. PCT/JP2024/014519 filed on Apr. 10, 2024, which claims the benefit of Japanese Patent Application No. 2023-065671 filed on Apr. 13, 2023, in the Japanese Intellectual Property Office, the disclosures of which are incorporated herein by reference in their entirety.

### TECHNICAL FIELD

The present invention relates to temperature switches that open or close an electrical circuit by a thermally actuated element.

### BACKGROUND ART

Patent Document 1 discloses a temperature switch that is attached to a ceramic heater. Patent Document 2 discloses a technique of assembling a temperature switch on a ceramic plate.

### REFERENCE DOCUMENT LIST

### Patent Documents

Patent Document 1: JP 4370355 B

Patent Document 2: JP 4440309 B

### SUMMARY OF THE INVENTION

### Problem to be Solved by the Invention

In Patent Document 1, although temperature followability is relatively high, the degree of freedom regarding attachment of the temperature switch is relatively low due to the heater and the temperature switch being in a one-to-one relationship. In Patent Document 2, the degree of freedom regarding attachment of the temperature switch is relatively high, but it is relatively difficult to perform attachment easily.

In view of these circumstances, an object of the present invention is to provide a temperature switch that has high thermal responsiveness and that can be easily attached to a heating element.

### Means for Solving the Problem

A temperature switch according to an embodiment of the present invention includes a base plate, a thermally actuated element that is disposed on the base plate, a movable plate that is partly joined to the base plate in such a way as to move according to reversal of the thermally actuated element, and that is provided with a movable contact, a fixed plate that is provided with a fixed contact that is capable of coming into contact with and separating from the movable contact, and an insulating plate that supports the base plate and the fixed plate. The base plate includes a main body part that is rectangular and that is supported by the insulating plate, and an extending part that is formed extending outward in a width direction from at least one of two end portions of the main body part in the width direction, and the extending part includes a plurality of bent portions, and a tip end portion of the extending part is flush with a bottom surface of the insulating plate.

### EFFECTS OF THE INVENTION

According to the present invention, there can be provided a temperature switch that has high thermal responsiveness and that can easily be attached to a heating element.

### BRIEF DESCRIPTION OF THE DRAWINGS

FIG. 1A is a perspective view showing a temperature switch according to a first embodiment.

FIG. 1B is a perspective view showing a state of the temperature switch according to the first embodiment during manufacture.

FIG. 1C is a perspective view showing a state of the temperature switch according to the first embodiment during manufacture.

FIG. 2 is a perspective view showing a temperature switch according to a second embodiment.

FIG. 3 is a perspective view showing a temperature switch according to a third embodiment.

FIG. 4A is a perspective view showing a temperature switch according to a fourth embodiment.

FIG. 4B is a perspective view showing a temperature switch according to a modification of the fourth embodiment.

FIG. 5 is a perspective view showing a temperature switch according to a fifth embodiment.

FIG. 6A is a perspective view showing a temperature switch according to a sixth embodiment.

FIG. 6B is a perspective view showing a temperature switch according to a modification of the sixth embodiment.

FIG. 7A is a perspective view showing a temperature switch according to a seventh embodiment.

FIG. 7B is a perspective view showing a temperature switch according to a modification of the seventh embodiment.

### MODE FOR CARRYING OUT THE INVENTION

Hereinafter, the present invention will be described based on illustrated embodiments. However, the present invention is not limited by the embodiments described below.

The embodiments described below are for increasing thermal responsiveness of a temperature switch and also for facilitating attachment of the temperature switch by extending a part of a metal member, of the temperature switch, where a thermally actuated element is to be attached and by causing a tip end portion of the extended part to come into direct contact with a heating element.

### First Embodiment

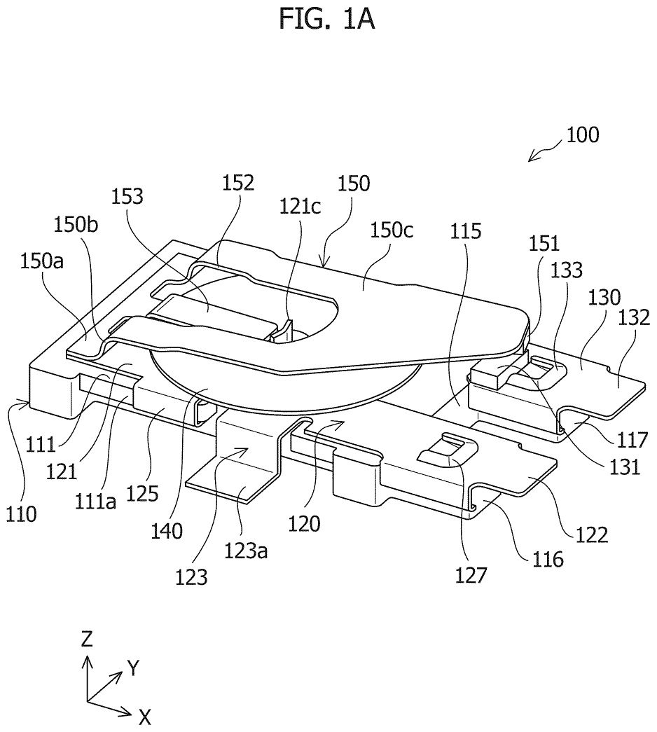

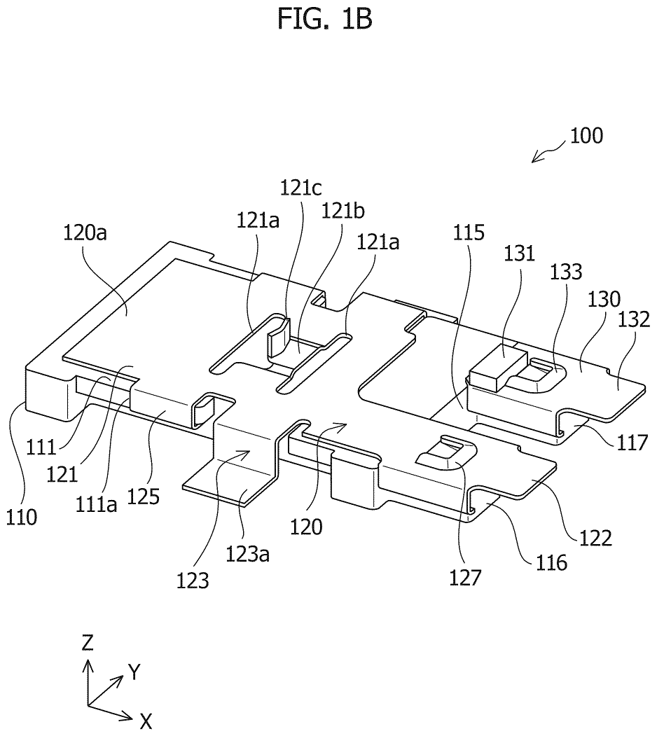

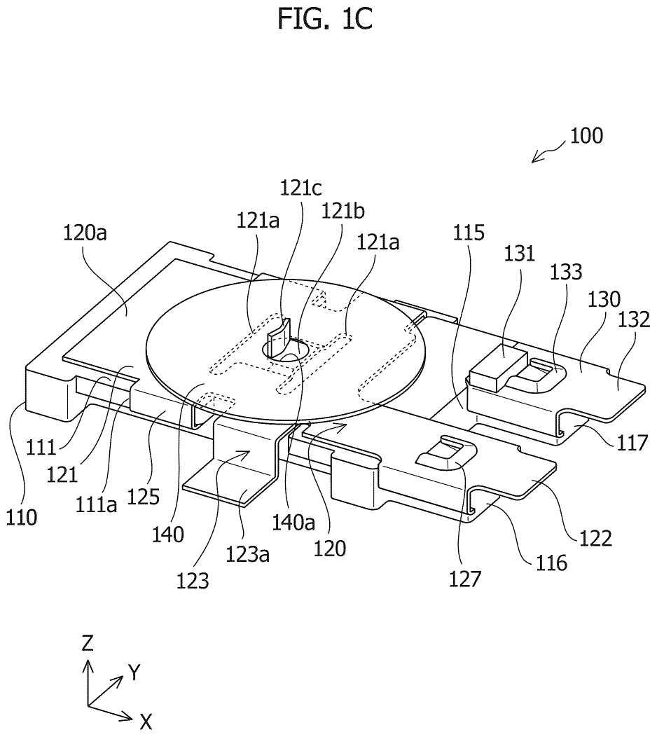

FIGS. 1A to 1C show a temperature switch 100 that is a substantially rectangular plate-shaped body as a whole. In the drawings, an x-axis, a y-axis, and a z-axis respectively show a lengthwise direction, a width direction, and a thickness direction of the temperature switch 100. An x-axis positive direction will also be referred to as a lengthwise first direction of the temperature switch 100, and an x-axis negative direction will also be referred to as a lengthwise second direction of the temperature switch 100. A y-axis positive direction (a left direction when facing the lengthwise first direction) will also be referred to as a width first direction of the temperature switch 100, and a y-axis negative direction will also be referred to as a width second direction of the temperature switch 100. A z-axis positive direction (a direction from a rear surface of the temperature switch 100 toward a front surface) will also be referred to as a thickness first direction of the temperature switch 100, and a z-axis negative direction will also be referred to as a thickness second direction of the temperature switch 100.

The temperature switch 100 includes an insulating plate 110, a base plate 120 and a fixed plate 130 disposed on the insulating plate 110, a bimetal 140 disposed on the base plate 120, and a movable plate 150 that is joined to the base plate 120 and that moves due to reversal of the bimetal 140. A material of the insulating plate 110 is ceramic having electrical insulating properties, and a material of the base plate 120, the fixed plate 130, the bimetal 140, and the movable plate 150 is metal having electrically conductive properties.

The insulating plate 110 has a narrow rectangular shape that is long in the lengthwise direction of the temperature switch 100. A cutout part 115 is formed at an end portion on the lengthwise first direction side of the insulating plate 110, at a center in the width direction. Accordingly, protruding parts 116 and 117 are formed that protrude in the lengthwise first direction from a main body part 111 of the insulating plate 110. The protruding part 117 is positioned on the y-axis positive direction side of the protruding part 116.

The base plate 120 includes a main body part 121 and a first terminal part 122. The main body part 121 has a narrow rectangular shape that is long in the lengthwise direction of the temperature switch 100, and is positioned on the main body part 111 of the insulating plate 110.

The first terminal part 122 is approximately on the protruding part 116 of the insulating plate 110, and is formed extending in the lengthwise first direction from an end portion on the lengthwise first direction side of the main body part 121. The first terminal part 122 is to be connected to an external circuit of the temperature switch 100.

An extending part 123 is formed extending outward in the width direction from an end portion on the width second direction side of the main body part 121 of the base plate 120. The extending part 123 is bent several times, and a tip end portion 123a of the extending part 123 is flush with a rear surface of the insulating plate 110.

The fixed plate 130 is positioned on the insulating plate 110 while being spaced apart from the base plate 120. More specifically, the fixed plate 130 is positioned spaced apart from the main body part 121 of the base plate 120 in the lengthwise first direction of the temperature switch 100, and is positioned spaced apart from the first terminal part 122 in the width first direction of temperature switch 100. A fixed contact 131 is provided on an end portion on the lengthwise second direction side of the fixed plate 130. An end portion on the lengthwise first direction side of the fixed plate 130 is a second terminal part 132 that is to be connected to the external circuit of the temperature switch 100.

The movable plate 150 has a narrow rectangular shape that is long in the lengthwise direction of the temperature switch 100. The movable plate 150 includes a base end portion 150a (an end portion on the lengthwise second direction side) that is joined to an end portion 120a on the lengthwise second direction side of the base plate 120, a rising portion 150b rising from an end portion on the lengthwise first direction side of the base end portion 150a, and a movable portion 150c extending in the lengthwise first direction from an upper end portion of the rising portion 150b.

A dimension of the movable portion 150c in the width direction is approximately the same between an end portion on the lengthwise second direction side and a substantially center portion in the lengthwise direction, but the dimension in the width direction is gradually reduced in the lengthwise first direction from the substantially center portion in the lengthwise direction. A movable contact 151 that faces the fixed contact 131 along the thickness direction of the temperature switch 100 and that is capable of coming into contact with and separating from the fixed contact 131 is provided on a rear surface of an end portion on the lengthwise first direction side of the movable portion 150c.

A hole 152 is formed in the movable plate 150, from the end portion of the movable portion 150c on the lengthwise second direction side to the substantially center portion in the lengthwise direction. Furthermore, a tongue part 153 that is positioned inside the hole 152 in a plan view of the temperature switch 100 is formed on the movable plate 150. The tongue part 153 includes a rising portion raised from the end portion, on the lengthwise first direction side, of the base end portion 150a of the movable plate 150, and a flat portion extending in the lengthwise first direction from an upper end portion of the rising portion.

Two long holes 121a that extend in the width direction of the temperature switch 100 and that are spaced apart in the lengthwise direction of the temperature switch are formed in the main body part 121 of the base plate 120, and a part sandwiched between the long holes is made a raised cut portion 121b that is elevated from the surroundings. A projecting portion 121c extending upward (in the z-axis positive direction) from the temperature switch 100 is formed on the raised cut portion 121b. The projecting portion 121c and a tip end portion of the tongue part 153 face each other along the lengthwise direction of the temperature switch 100.

The bimetal 140 having a circular shape is disposed on the base plate 120. A hole 140a is formed in a center portion of the bimetal 140, and the projecting portion 121c is engaged with the hole 140a. The center portion of the bimetal 140 is pressed against the raised cut portion 121b by the tip end portion of the tongue part 153. The tip end portion 123a of the extending part 123 is positioned on an outer side of the bimetal 140 in the width direction of the temperature switch.

Attachment of the base plate 120 to the insulating plate 110 will be described. A thin portion 111a that is made thin along the width direction is formed at a part of the main body part 111 of the insulating plate 110 positioned below the main body part 121 of the base plate 120. Wall parts 125 protruding downward from both edge portions of the main body part 121 of the base plate 120 in the width direction are provided at positions coinciding with the thin portion 111a in the lengthwise direction, and the two wall parts 125 hold the thin portion 111a.

Furthermore, a thin portion 116a that is made thin along the width direction in the same manner as the thin portion 111a is formed at a part of the protruding part 116. Wall parts protruding downward from both edge portions of the first terminal part 122 in the width direction are provided, and the two wall parts hold the thin portion 116a.

Moreover, a stopper 127 is provided at a part of the first terminal part 122 to be engaged with the insulating plate 110.

The base plate 120 is attached to the insulating plate 110 in this manner.

Attachment of the fixed plate 130 to the insulating plate 110 will be described.

A thin portion 117a that is made thin along the width direction in the same manner as the thin portions 111a and 116a is formed at a part of the protruding part 117. Wall parts protruding downward from both edge portions of the second terminal part 132 in the width direction are provided, and the two wall parts hold the thin portion 117a.

Furthermore, a stopper 133 is provided at a part of the second terminal part 132 to be engaged with the insulating plate 110.

The fixed plate 130 is attached to the insulating plate 110 in this manner.

At the time of use, the temperature switch 100 is fixed to a heating element (such as a ceramic heater embedded in a hair straightener), not shown, with a rear surface in contact with the heating element. At a normal temperature, the bimetal 140 is curved in a manner protruding upward, and the fixed contact 131 and the movable contact 151 are in contact with each other. That is, the base plate 120 including the first terminal part 122, the movable plate 150, and the fixed plate 130 including the second terminal part 132 are electrically connected.

When the temperature rises from the normal temperature and reaches a predetermined temperature, the shape of the bimetal 140 is reversed so that the bimetal 140 protrudes downward. Due to deformation of the bimetal 140, the movable portion 150c of the movable plate 150 is raised, and the movable contact 151 separates from the fixed contact 131. As a result, the base plate 120 including the first terminal part 122 and the fixed plate 130 including the second terminal part 132 are electrically disconnected.

As described above, the tip end portion 123a of the extending part 123 is positioned on the outer side of the bimetal 140 disposed on the base plate 120, in the width direction of the temperature switch. Heat is transferred from the tip end portion 123a in contact with the heating element to the bimetal 140 through the base plate 120 that is made of metal. A rate of such heat transfer is higher than a rate of heat transfer to the bimetal 140 through the insulating plate 110 that is made of ceramic and that is attached to the heating element. Because the tip end portion 123a is provided, thermal responsiveness to temperature of the heating element is increased compared to when there is no tip end portion 123a.

The bimetal is mounted on the raised cut portion provided on the base plate, and an area around the center portion of the bimetal is pressed by the tongue part. At the base plate, the extending part is positioned on an outer side of the raised cut portion in the width direction. Heat from a heating surface is collected at the tip end portion of the extending part, and is transferred to the bimetal through the raised cut portion of the base plate.

### Second Embodiment

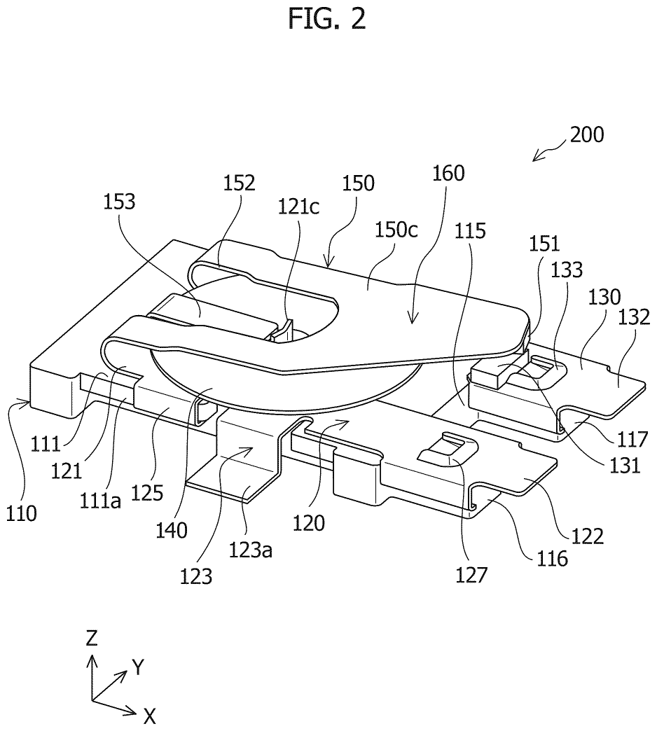

The base plate 120 and the movable plate 150 shown in FIG. 1A may be made into a plate 160 of a temperature switch 200 shown in FIG. 2, where the plate 160 is bent in a substantially U-shape when seen in the width direction. With the plate 160, one end side of a bent portion is the base plate 120, and the other end side of the bent portion is the movable plate 150.

### Third Embodiment

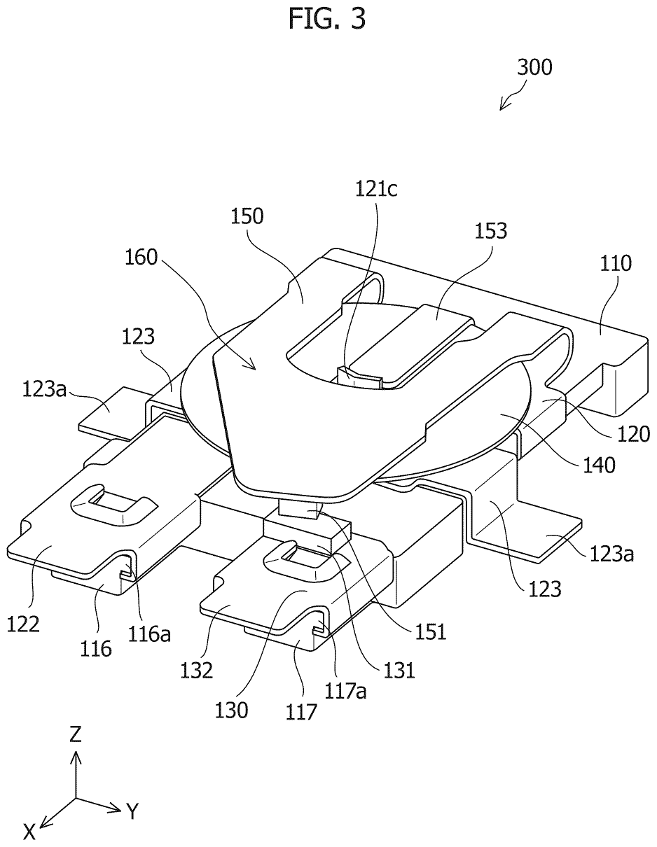

As shown in FIG. 3, in relation to a temperature switch 300, the extending part 123 and the tip end portion 123a that extend outward in the width direction may be formed on both end portions of the main body part 121 of the base plate 120 in the width direction.

Because the tip end portion 123a is provided on both end portions in the width direction of the temperature switch, orientation of the temperature switch becomes stable. Moreover, because there are two heat conduction paths to the bimetal, thermal responsiveness is further increased.

### Fourth Embodiment

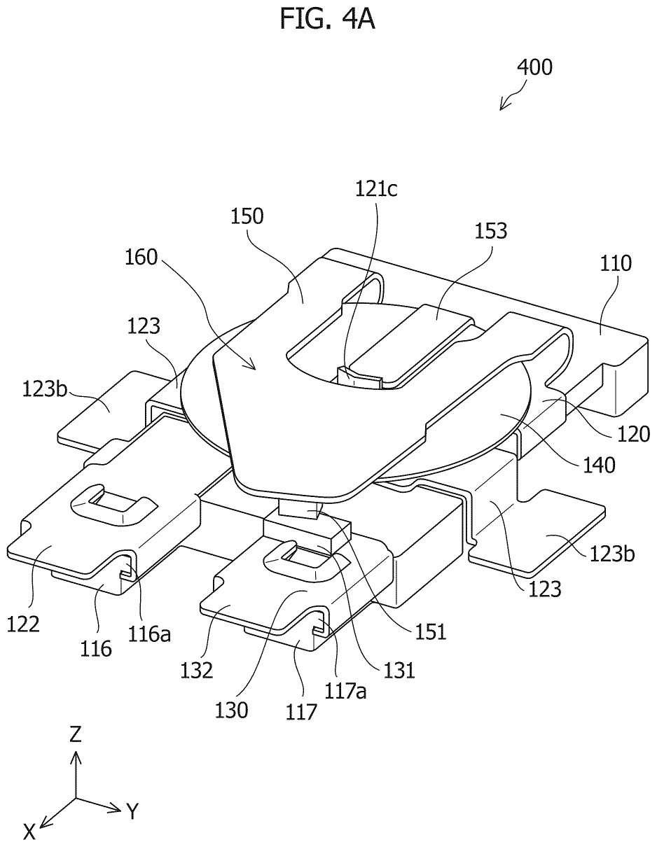

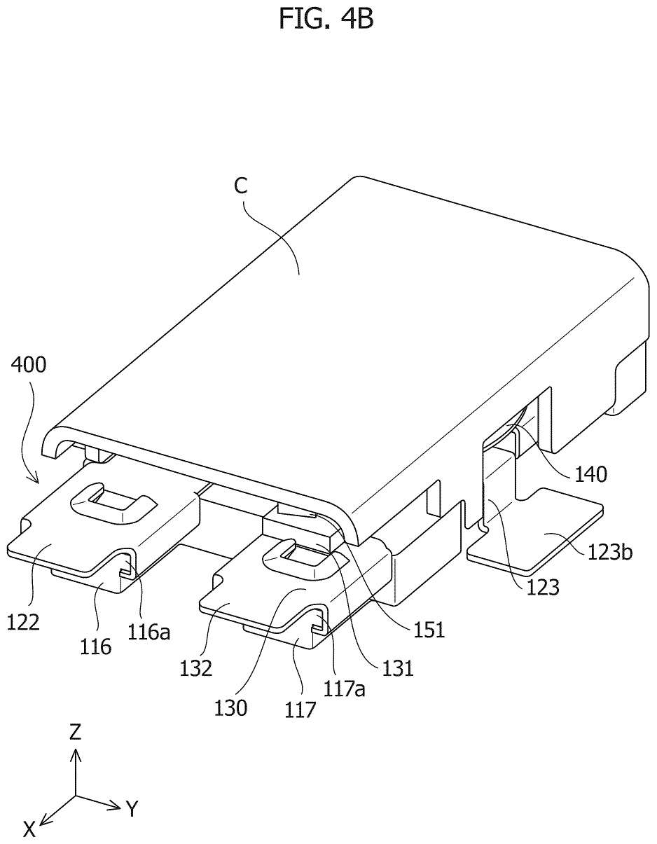

As shown in FIG. 4A, in relation to a temperature switch 400, a dimension of a tip end portion 123b of the extending part 123 in the lengthwise direction of the temperature switch may be made greater than a dimension of a trunk portion of the extending part in the lengthwise direction of the temperature switch. Heat collection property of the temperature switch can thus be increased. The tip end portion 123b may be joined to a metallic or insulating heating surface of the heating element, or a heating surface, formed from an insulating material, of the heating element. As joining methods, there are contact, adhesion, welding including soldering, and ultrasonic welding.

As shown in FIG. 4B, a cover C may be attached from above to cover functional parts (the main body part 121 of the base plate 120, the bimetal 140, and the movable plate 150) of the temperature switch 400.

### Fifth Embodiment

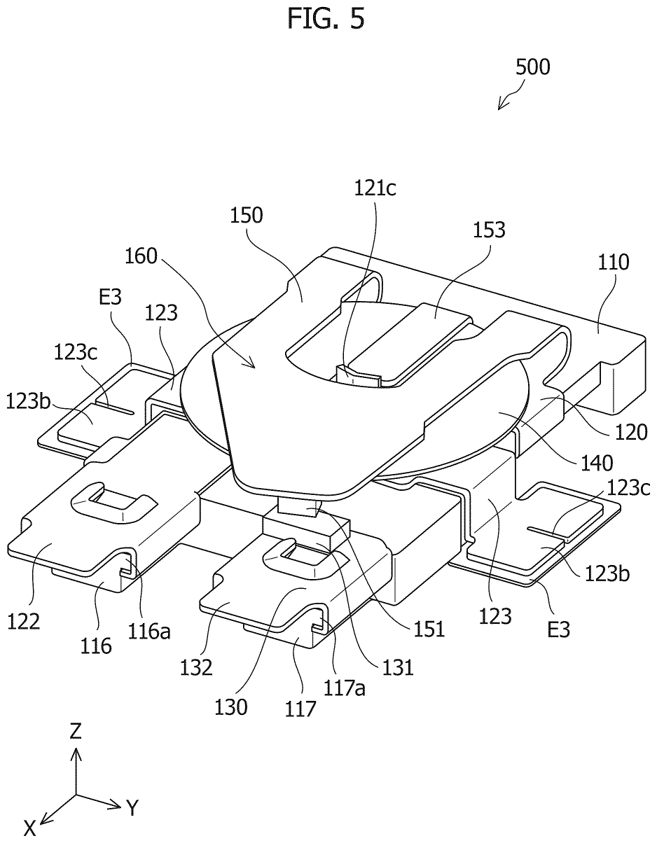

As shown in FIG. 5, in relation to a temperature switch 500, a slit 123c that extends in the width direction of the temperature switch may be provided in the tip end portion 123b. The tip end portion 123b may be joined by welding including soldering or ultrasonic welding, for example, to a metallized electrode E3 provided on a surface of a heating element (not shown) formed from an insulating material.

In the case of contact or adhesion, there is an issue of how to reduce thermal resistance of a contact surface or an adhesion surface. Accordingly, a heat-receiving surface can be increased as in the case of the tip end portion 123b according to the fourth embodiment.

In the case of welding, the tip end portion of the extending part of the temperature switch is welded to an electrode part of the heating element. More specifically, resistance welding called series welding is performed.

Two welding electrodes are brought into contact with an upper surface of the tip end portion 123b and are welded. A welding current flows through the tip end portion of the extending part of the temperature switch from one welding electrode, and flows to the electrode part of the heating element below the tip end portion. Furthermore, the welding current flows from the electrode part of the heating element to the other welding electrode through the tip end portion of the extending part of the temperature switch. Resistance welding is thus performed. In the case in which a resistivity of the tip end portion 123b is small, the welding current flows from one welding electrode to the other welding electrode through the tip end portion 123b without flowing through the electrode part of the heating element, and sufficient welding strength is possibly not obtained. By providing the above-mentioned slit 123c according to the fifth embodiment in the tip end portion 123b, a current in the lengthwise direction of the temperature switch may be limited in relation to the tip end portion 123b, and sufficient welding strength can be obtained.

### Sixth Embodiment

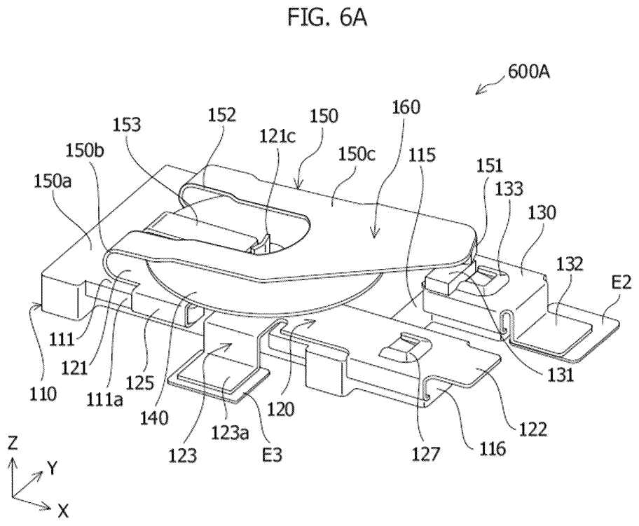

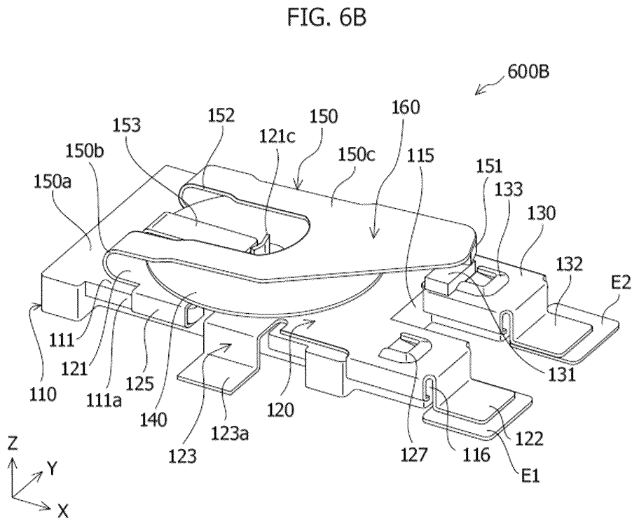

As shown in FIG. 6A, in relation to a temperature switch 600A, an end portion in the lengthwise first direction of the second terminal part 132 may be bent a plurality of times to make a tip end portion thereof flush with a rear surface of the temperature switch. A metallized electrode E2 of the heating element is positioned on a rear surface of the tip end portion of the second terminal part 132, and the metallized electrode E3 of the heating element is positioned on a rear surface of the tip end portion 123a of the extending part 123. The metallized electrodes are a part of the external circuit of the temperature switch, and details thereof will be given later. The extending part 123 is used not only for heat conduction but also for electrical connection. Accordingly, connection to the external circuit of the temperature switch and fixing of the temperature switch can be achieved at the same time. As a result, characteristics can be improved, and also, the number of steps can be reduced.

When an electrode is provided on a surface of the heating element, the tip end portion of the extending part can be electrically connected to the electrode.

In the case in which the heating element is formed of a ceramic substrate, a metallized electrode can be provided on a surface of the ceramic substrate. The tip end portion of the extending part and the metallized electrode can be joined by resistance welding, ultrasonic welding, laser welding or the like, and the temperature switch can be connected to the external circuit.

By such joining of the tip end portion, fixing of a main body of the temperature switch to the surface of the heating element, and connection of the temperature switch to an electrical circuit can be achieved at the same time.

As described above, in FIG. 6A, the second terminal part 132 is extended and the tip end portion of the second terminal part 132 is made flush with the rear surface of the temperature switch, in addition to the tip end portion of the extending part. The first terminal part 122 has electrically the same polarity as the tip end portion 123a of the extending part 123, and thus, the first terminal part 122 does not have to be processed and fixed.

Alternatively, as shown in FIG. 6B, in relation to a temperature switch 600B, an end portion of the first terminal part 122 in the lengthwise first direction may be bent a plurality of times to make a tip end portion thereof flush with the rear surface of the temperature switch. A metallized electrode E1 is provided on a rear surface of the tip end portion of the first terminal part 122. In this case, the metallized electrode E3 does not have to be provided on the rear surface of the extending part 123a.

### Seventh Embodiment

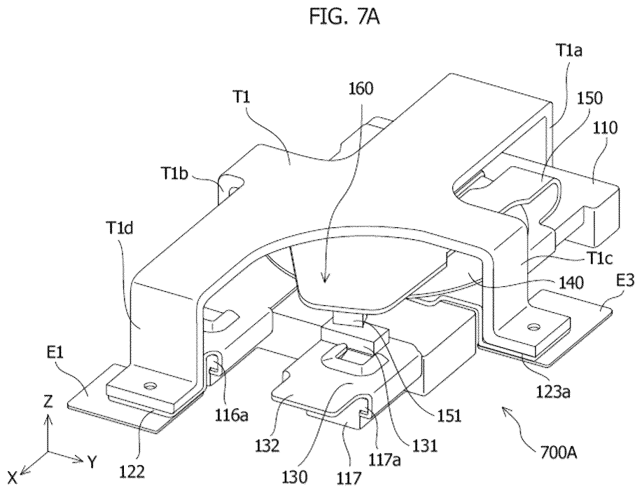

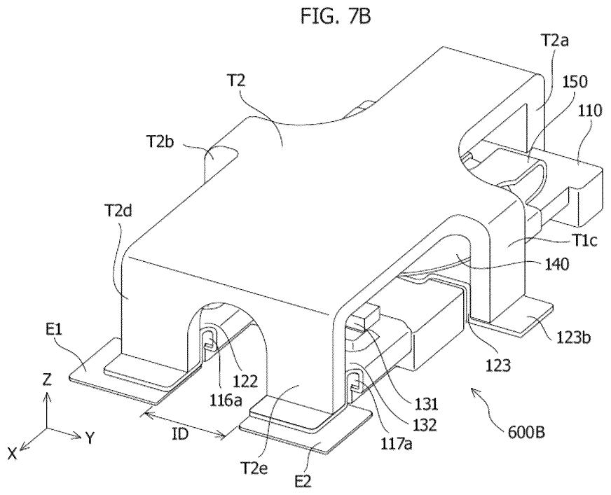

As shown in FIG. 7A, in relation to a temperature switch 700A, an end portion of the first terminal part 122 in the lengthwise first direction may be bent a plurality of times to make a tip end portion thereof flush with the rear surface of the temperature switch. The metallized electrode E1 is provided on the rear surface of the tip end portion of the first terminal part 122. The end portion of the second terminal part 132 in the lengthwise first direction is not bent, and is not provided with the metallized electrode E2. To improve heat conduction, the metallized electrode E3 is provided on the rear surface of the tip end portion 123a of the extending part 123.

Furthermore, a fixture T1 can be provided to fix the temperature switch 700A to the heating element. The fixture T1 is made of metal, and includes a plate-shaped main body part that is positioned above the temperature switch and that is parallel to the surface of the temperature switch, and four leg portions T1a to T1d that protrude downward from the main body part.

An end surface of the temperature switch in the lengthwise second direction is held by the leg portion T1a.

The two tip end portions 123a that are flush with the rear surface of the temperature switch are pressed against the heating element by the leg portion T1b and the leg portion T1c.

The first terminal part 122 that is flush with the rear surface of the temperature switch is pressed against the heating element by the leg portion T1d.

By pressing the tip end portion of the extending part from above using the fixture, the temperature switch can be fixed, and also, electrical joining can be achieved. The second terminal part 132 having a different polarity from the tip end portion 123a is connected to the external circuit without using the fixture T1 that is made of metal.

As shown in FIG. 7B, a fixture T2 for fixing the temperature switch 600B shown in FIG. 6B to the heating element can be provided. The fixture T2 includes a plate-shaped main body part that is positioned above the temperature switch and that is parallel to the surface of the temperature switch, and five leg portions T2a to T2e that protrude downward from the main body part.

The end surface of the temperature switch in the lengthwise second direction is held by the leg portion T2a.

The two tip end portions 123a that are flush with the rear surface of the temperature switch are pressed against the heating element by the leg portion T2b and the leg portion T2c.

The first terminal part 122 that is flush with the rear surface of the temperature switch is pressed against the heating element by the leg portion T2d.

The second terminal part 132 that is flush with the rear surface of the temperature switch is pressed against the heating element by the leg portion T23.

Additionally, a reference symbol ID indicates an insulation distance.

As described above, FIG. 7A shows an example in which the fixture T1 made of metal is used. Upper surfaces of three fixing parts having electrically the same polarity (the two extending parts 123a and the first terminal part 122) are pressed by dot-shaped or line-shaped contact portions provided on lower surfaces of the leg portions of the fixture T1. Thanks to such dot contact or line contact, heat dissipation to the fixture T1 is reduced. The heating element and the temperature switch can be brought into close contact with each other by pressing the fixture T1 at around the center with a clip (not shown) or the like.

In the case in which the fixture T2 is formed from a heat-resistant insulating member, electrical connection and fixing can be achieved by pressing four fixing parts (the two extending parts 123a, the first terminal part 122, and the second terminal part 132) with the fixture T2 at the same time, as shown in FIG. 7B.

If an entire pressing surface of the fixture T2 is in contact with entire upper surfaces of the fixing parts, heat from the fixing parts is possibly transferred to the fixture and not the bimetal. Accordingly, in relation to parts that come into contact with the upper surfaces of the fixing parts, to suppress heat transfer, dot-shaped or line-shaped projecting portions are provided on lower surfaces of the leg portions of the fixture T2 to reduce contact areas.

Furthermore, the fixture may be assembled to a heating surface with a clip (not shown) or the like such that the main body of the temperature switch and the heating element are brought into close contact with each other.

For example, the fixture T2 in FIG. 7B is formed from an insulating material such as heat-resistant resin or ceramic. Because the fixture T2 has insulation properties, both the first terminal part 122 and the second terminal part 132 are pressed by the leg portions of the fixture T2. At this time, if there are electrode parts of the heating element on lower surfaces of both terminal parts, electrical connection is achieved at the same time. Line-shaped projecting portions are provided on lower surfaces of the leg portions of the fixture T2 that contact the upper surfaces of the tip end portions 123a of the extending parts on both sides of the bimetal in the width direction to limit heat transfer from the bimetal to the fixture.

With a structure in which the extending part 123 is not electrically connected to the external circuit of the temperature switch and current flows in from the first terminal part 122, load current flows through a large area of the bimetal. In contrast, in the case in which the extending part 123 is electrically connected to the external circuit of the temperature switch, a region where the load current flows is small relative to the area of the bimetal, and influence of Joule heat by the load current can be reduced.

Thermal properties of materials used for the temperature switch are compared as follows.

Thermal conductivity of porcelain is 1.5 [W/m·K], thermal conductivity of copper is 403 [W/m·K], and thermal conductivity of stainless steel is about 20 [W/m·K]. Thermal conductivity of a material obtained by three-layer cladding the materials with copper at a center is about 270 [W/m·K].

For example, in the case in which the thickness of the insulating plate made of porcelain such as alumina is 1.5 mm and the thickness of the fixed plate is 0.15 mm, thermal conductivity of a metal member that is directly and integrally formed from the fixing part to a bimetal support part is greater even when taking into account width and length of the extending part.

Accordingly, in the case in which the extending part is provided on both sides of the insulating plate in the width direction, heat collected by the tip end portions of the extending parts can be transferred to a thermally actuated element through the extending parts that are formed by being bent a plurality of times. Heat transfer from the heating element to the thermally actuated element is faster through the extending parts than through the insulating plate.

In the case of thermally coupling the extending part to the heating element, the extending part can sometimes be provided only on one of two sides in the width direction due to restrictions regarding insulation distance. However, also in such a case, it suffices if an area of the extending part is increased, or a width of the extending part is increased.

Thermal conductivity of metal is higher than thermal conductivity of ceramic. Accordingly, by providing the extending part and fixing the tip end portion, heat from the heating element can be swiftly transferred to the thermally actuated element. As a result, thermal responsiveness is increased.

A thermally actuated element such as the bimetal is formed into a shallow dome shape so as to perform snapping. When attachment to the base plate is performed by pressing an outer peripheral part of the thermally actuated element, a stress is applied in a reversal direction of the thermally actuated element, and a reversal temperature of the thermally actuated element itself is greatly affected.

In contrast, a center portion of the thermally actuated element can be attached to the raised cut portion of the base plate while preventing the outer peripheral part of the thermally actuated element from coming into contact with the base plate, and the vicinity of the center portion of the thermally actuated element can be pressed. In this case, a stress in the reversal direction of the thermally actuated element is not applied, and thus, a change in the reversal temperature of the thermally actuated element is reduced, and moreover, the thermally actuated element is brought into contact with the base plate and heat transfer from the heating element to the thermally actuated element is performed.

Furthermore, when the base plate and the movable plate are integrally formed, the amount of metal material that is used is small, and smaller heat capacity can be achieved at the same performance. This leads to an increase in thermal responsiveness. Also, the number of components and the number of processing steps can be reduced.

In relation to the extending part, thermal resistance becomes smaller and heat transfer becomes faster in the order of contact, adhesion, and welding. Furthermore, thermal resistance can be reduced by increasing an area of the extending part.

In the case of adhesion, a material with high heat resistance, such as epoxy resin or silicon-based adhesive, can be used.

Welding can be performed in a case in which an electrode is formed on a surface of the heating element. Resistance welding and laser welding can be performed. By providing the slit in the extending part, a current path can be made clear at the time of series welding that is a type of resistance welding, and weldability is improved. In the case in which transverse ultrasonic vibration is used, metal pieces, that is, the fixed plate and the electrode, are joined.

By providing a similar fixing part to the terminal part of the temperature switch, fixing of the main body of the temperature switch and electrical connection to the heating element can be achieved at the same time.

Furthermore, by pressing the fixing part of the temperature switch by using the fixture, the main body of the temperature switch can be fixed. In the case in which there is an electrode on the surface of the heating element, and the fixture is formed from an insulating material, electrical connection can be achieved through pressing.

The following supplements are disclosed in relation to the embodiments described above.

### Supplement 1

A temperature switch including:
a base plate;
a thermally actuated element that is disposed on the base plate;
a movable plate that is partly joined to the base plate in such a way as to move according to reversal of the thermally actuated element, and that is provided with a movable contact;
a fixed plate that is provided with a fixed contact that is capable of coming into contact with and separating from the movable contact; and
an insulating plate that supports the base plate and the fixed plate, in which
the base plate includes a main body part that is rectangular and that is supported by the insulating plate, and an extending part that is formed extending outward in a width direction from at least one of two end portions of the main body part in the width direction, and
the extending part includes a plurality of bent portions, and a tip end portion of the extending part is flush with a bottom surface of the insulating plate.

### Supplement 2

The temperature switch according to Supplement 1, in which
the thermally actuated element is attached to a raised cut portion formed on the base plate,
a center portion of the thermally actuated element is pushed toward the raised cut portion by a part of the movable plate, and
a stopper for fixing the base plate to the insulating plate is provided on the base plate.

### Supplement 3

The temperature switch according to Supplement 1, in which the base plate and the movable plate are integrally formed into a shape that is substantially U-shaped in side view.

### Supplement 4

The temperature switch according to Supplement 1, in which the tip end portion of the extending part contacts a heating element.

### Supplement 5

The temperature switch according to Supplement 1, in which the tip end portion of the extending part is joined to an electrode part of a heating element.

### Supplement 6

The temperature switch according to Supplement 5, in which a slit is formed in the tip end portion of the extending part.

### Supplement 7

The temperature switch according to Supplement 1, in which
the base plate is provided with a first terminal plate of the temperature switch,
the fixed plate is provided with a second terminal plate of the temperature switch, and
at least the second terminal plate includes a plurality of bent portions, and a tip end portion of at least the second terminal plate is flush with the bottom surface of the insulating plate.

### Supplement 8

The temperature switch according to Supplement 1, further including a fixture that presses the tip end portion of the extending part from an upper surface against a heating element.

Although embodiments of the present invention have been described, the present invention is not limited by the embodiments described above, and various modifications and changes can be made based on technical concept of the present invention.

### REFERENCE SYMBOL LIST

100 Temperature switch
110 Insulating plate
111 Main body part
111a Thin portion
115 Cutout part
116 Protruding part
117 Protruding part
120 Base plate
120a End portion
121 Main body part
121a Long hole
121b Raised cut portion
121c Projecting portion
122 First terminal part
123 Extending part
123a Tip end portion
125 Wall part
127 Stopper
130 Fixed plate
131 Fixed contact
132 Second terminal part
133 Stopper
140 Bimetal
140a Hole
150 Movable plate
150a Base end portion
150b Rising portion
150c Movable portion
151 Movable contact
152 Hole
153 Tongue part

1. A temperature switch comprising:
a base plate;
a thermally actuated element that is disposed on the base plate;
a movable plate that is partly joined to the base plate in such a way as to move according to reversal of the thermally actuated element, and that is provided with a movable contact;
a fixed plate that is provided with a fixed contact that is capable of coming into contact with and separating from the movable contact; and
an insulating plate that supports the base plate and the fixed plate, wherein
the base plate includes a main body part that is rectangular and that is supported by the insulating plate, and an extending part that is formed extending outward in a width direction from at least one of two end portions of the main body part in the width direction, and
the extending part includes a plurality of bent portions, and a tip end portion of the extending part is flush with a bottom surface of the insulating plate.

2. The temperature switch according to claim 1, wherein
the thermally actuated element is attached to a raised cut portion formed on the base plate,
a center portion of the thermally actuated element is pushed toward the raised cut portion by a part of the movable plate, and
a stopper for fixing the base plate to the insulating plate is provided on the base plate.

3. The temperature switch according to claim 1, wherein the base plate and the movable plate are integrally formed into a shape that is substantially U-shaped in side view.

4. The temperature switch according to claim 1, wherein the tip end portion of the extending part contacts a heating element.

5. The temperature switch according to claim 1, wherein the tip end portion of the extending part is joined to an electrode part of a heating element.

6. The temperature switch according to claim 5, wherein a slit is formed in the tip end portion of the extending part.

7. The temperature switch according to claim 1, wherein
the base plate is provided with a first terminal plate of the temperature switch,
the fixed plate is provided with a second terminal plate of the temperature switch, and
at least the second terminal plate includes a plurality of bent portions, and a tip end portion of at least the second terminal plate is flush with the bottom surface of the insulating plate.

8. The temperature switch according to claim 1, further comprising a fixture that presses the tip end portion of the extending part from an upper surface against a heating element.
